(19) United States
(12) Patent Application Publication
(10) Pub. No.: US 2025/0001650 A1
(43) Pub. Date: Jan. 2, 2025

(54) Powder Hopper for the Gravity-Driven Feeding of Powdered Electrode Precursor Material Into a Nip of a Dry Electrode Caldender, Corresponding Assembly, and Corresponding Method

(71) Applicants: Matthews International GmbH, Vreden (DE); Matthews International Corporation, Pittsburgh, PA (US)

(72) Inventors: Thomas HACKFORT, Ahaus-Altstätte (DE); Jörg GOTTSZKY, Vreden (DE); Carsten KLEINGRIES, Vreden (DE)

(21) Appl. No.: 18/705,726

(22) PCT Filed: Apr. 28, 2022
(86) PCT No.: PCT/DE2022/100315

§ 371 Date: Apr. 29, 2024

Related U.S. Application Data
(60) Provisional application No. 63/275,863, filed on Nov. 4, 2021.

(51) Int. Cl. B29C 31/02; B29C 43/24; B29C 43/34; B29C 43/58; B29L 31/34; G01F 23/292; G01N 9/02; H01G 13/00; H01M 4/04

(52) U.S. Cl. CPC B29C 31/02; B29C 43/24; B29C 43/34; B29C 43/58; G01F 23/292; G01N 9/02; B29C 2043/5875; B29L 2031/3406; G01N 2009/024; H01G 13/00; H01M 4/0435

(57) ABSTRACT

The invention relates to a powder hopper (101) for the gravity-driven feeding of powdered electrode precursor material (102) into a nip of a dry electrode calendar (2), said powder hopper comprising: a powder feed opening (105) for feeding powdered electrode precursor material (102) into the powder hopper; and a powder outlet opening (106) for metering the powdered electrode precursor material from the powder hopper into a nip, the cross-section of the powder hopper tapering between the powder feed opening and the powder outlet opening, and the powder hopper having a level detection means (103) for detecting the powder level of the powder hopper. The invention also relates to: a corresponding assembly consisting of a powder hopper and a first and a second roller that form a nip; and a method for operating a powder hopper.

The invention relates to a powder hopper for feeding powdered electrode precursor material into a nip of a dry electrode calender for producing a dry electrode web.

Electrodes can be used in electrical energy storage cells, which are widely used to power electronic, electromechanical, electrochemical, and other useful devices. Such cells include batteries such as primary chemical cells and secondary (rechargeable) cells, fuel cells, and various types of capacitors, including ultracapacitors. Electrodes can also be used in water treatment plants. Electric mobility in particular is clearly growing. The energy source in electrically powered vehicles, the battery, accounts for a large part of the costs. This is directly related to their production. This requires efficient and cost-effective production with a simultaneous increase in energy density. The calendering process within the process chain for producing lithium-ion battery cells is crucial for this.

The key components for the storage potential of an energy storage device are the electrodes. The electrochemical capabilities of electrodes, such as the capacity and efficiency of battery electrodes, are determined by various factors. These include the distribution of the active material, the binder, and the additives, the physical properties of the materials contained therein, such as particle size and surface area of the active material, the surface properties of the active materials and the physical properties of the electrode film, such as density, porosity, cohesion, and adhesion to a conductive element. Dry processing systems and methods traditionally use a processing step with high shear and/or high pressure to break up and mix the electrode film materials. Such systems and methods can contribute to structural advantages over wet-produced electrode films. However, the high processing pressures and large system dimensions (and thus the large space requirement) required for the production of dry, self-supporting electrode films and dry electrodes leave room for improvements.

A device and a method for producing a dry electrode are known from US 2020/0 072 612 A1, which on the one hand describes manual feeding of powdered electrode precursor material into a nip and on the other hand the use of powder hoppers for feeding the material. However, the solutions described have the disadvantage that the feed of the material in this way is inaccurate and can result in an inhomogeneously formed electrode track which has variations in its thickness and width.

It is therefore the object of the present invention to improve a powder hopper for feeding powdered electrode precursor material into a nip in such a way that the feed of the material can be better metered.

The invention is achieved by the features of the independent claims. Advantageous embodiments are described in the dependent claims.

Accordingly, a powder hopper for gravity-driven feeding of powdered electrode precursor material into a nip of a dry electrode calender is provided, having a powder feed opening for feeding powdered electrode precursor material into the powder hopper and a powder outlet opening for metering the powdered electrode precursor material from the powder hopper into a nip, wherein the cross section of the powder hopper tapers between the powder feed opening and the powder outlet opening, characterized in that the powder hopper has a level detection device for determining the powder level of the powder hopper. The powder hopper can be aligned so that the powder feed opening is located above the powder outlet opening, in particular is arranged vertically above it. The powder feed opening and/or the powder outlet opening can have a rectangular cross section.

In relation to the solution known from the prior art, the invention has the advantage that the fill level of the powder hopper can be continuously monitored during the process. This makes it possible to improve the homogeneity of the electrode track produced, in particular to produce a homogeneous thickness and/or a homogeneous track width. Furthermore, the fill level monitoring enables timely detection of errors in the operating process, for example if there is too little or too much powder in the hopper, so that the system can be switched off in time if necessary to avoid serious damage to the system.

It can be provided that the powder hopper furthermore comprises a weight detection device for determining the weight of the powder in the powder hopper. It can be provided that the level detection device and the weight detection device are connected to a control unit of the system and send the determined level and weight data to the control unit. The control unit can continuously determine the density of the powder in the hopper by comparing the fill level data with the weight data. This has the advantage that the powder feed into the hopper can be controlled based on the determined density and thus the powder fed into the nip has a constant density. This is particularly important because the powdered electrode precursor material is already compacted in the hopper, which continuously increases in the direction of the powder outlet opening due to the powder material pressing down on the lower powder layers from above. The compaction is further increased by simply feeding the powder into the powder hopper, wherein the powder falls, for example, from a feed device into the powder hopper and the vertical distance of the feed device from the powder hopper or from the powder contained therein influences the degree of compaction of the powder in the hopper.

It can be provided that the weight detection device comprises at least one load cell on which the powder hopper is supported. It can be provided that the powder hopper has at least one first and at least one second load cell as well as at least two support tabs which project laterally on opposite sides of the powder hopper, wherein the powder hopper is supported via one of the tabs on the at least one first load cell and via the opposite other tab on the at least one second load cell. To detect the powder weight in the powder hopper, the at least one load cell can send the measured weight to the control unit, in which the tare weight of the powder hopper is then subtracted from the measured value.

It can be provided that the powder hopper has a width extending transversely to the nip and a length extending along the nip, wherein the width of the powder hopper decreases between the powder feed opening and the powder outlet opening and the length of the powder hopper is constant between the powder feed opening and the powder outlet opening. In particular, it can be provided that the powder feed opening and the powder outlet opening are vertically spaced apart from one another. The powder hopper can have two opposite side walls which delimit the length of the hopper and which can in particular be aligned vertically. The support tabs can be bent away from the side walls, in particular from the upper edge of the side walls. The powder hopper can have two opposite side walls which delimit the width of the powder hopper and which are adjacent to the powder feed opening. These walls adjacent to the powder feed opening can be aligned substantially vertically. Immediately adjacent to the powder outlet opening, there may be two further opposite wall sections which delimit the width of the powder hopper, one of which may be aligned substantially vertically and the other may be aligned inclined and tapering in cross section towards the powder outlet opening.

The fill level detection device can have at least one first fill level sensor in the area above the powder outlet opening. The first fill level sensor can, for example, be arranged in the vertical wall section adjacent to the powder outlet opening. The first fill level sensor can, for example, be arranged in a range of 2 cm-10 cm above the powder outlet opening.

The fill level detection device can have at least one second fill level sensor in the area below the powder feed opening. The second fill level sensor can, for example, be arranged in the vertical wall section adjacent to the powder feed opening. The second fill level sensor can, for example, be arranged in a range of 2 cm-10 cm below the powder feed opening.

For example, the fill level detection device can comprise at least one capacitive fill level sensor. The principle of capacitive fill level measurement is based on the capacitance change of a capacitor. The capacitive sensor and the powder hopper wall form a capacitor whose capacitance depends on the amount of powder in the hopper, wherein an empty hopper has a lower capacitance and a filled hopper has a higher capacitance. It can be provided that the fill level sensor has a plurality of sensor units distributed over the length of a side wall of the powder hopper and arranged at substantially the same height. The sensor units can be, for example, light barriers or capacitive sensors. By distributing the sensors over the length of the powder hopper, it can be determined whether the powder hopper is evenly filled with powder over its entire length. For example, the powder hopper can have multiple measuring levels, in each of which a plurality of fill level sensors can be arranged horizontally spaced apart from one another, i.e., at the same height. For example, four or more fill level sensors can be provided per measuring level.

It can be provided that the side wall of the powder hopper which has the plurality of sensor units is arranged essentially vertically. Accordingly, it can be provided that in the case of multiple measuring levels, the side wall sections having the sensors are each aligned vertically and the hopper can therefore have multiple vertical wall sections. If multiple measuring planes are provided, the sensors can all be located on the same side of the hopper, so that the side of the hopper opposite to the sensors has only a single inclined wall section.

The first fill level sensor can thus have a first plurality of sensor units distributed over the length of a first substantially vertical side wall of the powder hopper and arranged at substantially the same height, and the second fill level sensor can have a second plurality of sensor units distributed over the length of a second substantially vertical side wall of the powder hopper and arranged at substantially the same height, wherein an inclined side wall connecting the first and the second side walls can be arranged between the first and the second side walls, which tapers the width of the powder hopper in the direction of the powder outlet opening.

The fill level detection device can furthermore comprise an optical fill level sensor additionally or alternatively to the capacitive fill level sensor. The optical fill level sensor can be directed spaced apart from the powder hopper through the powder feed opening onto the interior of the powder hopper. The optical fill level sensor can be arranged above the powder hopper. The detection range of the optical fill level sensor can comprise at least the entire length and the entire width of the powder hopper. The optical fill level sensor can be configured to detect the filling volume of the powder hopper with powdered electrode precursor material. For this purpose, the optical fill level sensor can have a camera which detects the surface relief of the powder in the hopper and compares it with a value of the total volume of the powder hopper stored in the control unit. The optical fill level sensor can thus also be configured to detect powder fill levels that are unevenly distributed over the length of the powder hopper.

The invention furthermore relates to an assembly comprising a powder hopper according to one of the preceding claims and a first and a second roll forming a nip, wherein the powder outlet opening of the powder hopper is arranged above and along the nip, so that the powdered electrode precursor material can be metered into the nip over this entire length of the powder outlet opening.

It can be provided that the assembly furthermore comprises a feed conveyor arranged above the powder hopper, by means of which powdered electrode precursor material can be conveyed into the nip. It can be provided that the feed conveyor is height-adjustable. It can be provided that the feed conveyor is a belt conveyor. It can furthermore be provided that the vertical adjustment device for adjusting the height of the feed conveyor is coupled to the control unit, and the control unit regulates the vertical position of the feed conveyor depending on the determined powder fill level in the powder hopper so that the distance between the feed conveyor and the powder surface in the hopper always remains constant. Alternatively, it can be provided that the control unit controls the vertical adjustment device in such a way that the density determined in the powder hopper always remains constant, so that the distance of the feed conveyor to the hopper is increased when the density falls below a target density and is reduced when the target density is exceeded. This allows the effect of compaction in the hopper caused by feeding the powder to be utilized in order to achieve a constant material density at the powder outlet opening.

The conveying speed of the feed conveyor can be regulated depending on the powder density determined in the powder hopper, wherein the powder density is calculated on the basis of the powder filling height determined via the fill level sensor and the powder mass determined via the weight detection device. It can be provided that the conveying speed is increased when the calculated powder density exceeds a first threshold value of a target range, and wherein the conveying speed is slowed down when the calculated powder density falls below a second threshold value of the target range.

The invention furthermore relates to a method for operating a powder hopper, comprising the following steps:
Determining the fill level of the powder hopper with powdered electrode precursor material;
Determining the weight of the powdered electrode precursor material located in the powder hopper;
Calculating the density of the powdered electrode precursor material located in the powder hopper from the determined fill level and the determined weight;
Regulating a flow of powdered electrode material conveyed into the powder hopper.

It can be provided that regulating the flow of powdered electrode material conveyed into the powder hopper comprises regulating a conveying speed of a feed conveyor connected upstream of the powder hopper. It can furthermore be provided that regulating the flow of powdered electrode material conveyed into the powder hopper comprises regulating a vertical distance between a feed device and the powder hopper.

Furthermore, it can be provided that determining the fill level of the powder hopper comprises determining using a capacitive and/or optical sensor. In this case, determining the fill level of the powder hopper can comprise determining the presence of powdered electrode precursor material on a first powder hopper level and determining the presence of powdered electrode precursor material on a second powder hopper level, wherein the height of the first powder hopper level can differ from the height of the second powder hopper level.

Furthermore, it can be provided that determining the weight of the powdered electrode precursor material located in the powder hopper comprises weighing the powder hopper minus the powder hopper weight.

Further details of the invention are explained using the figures below. In the figures:

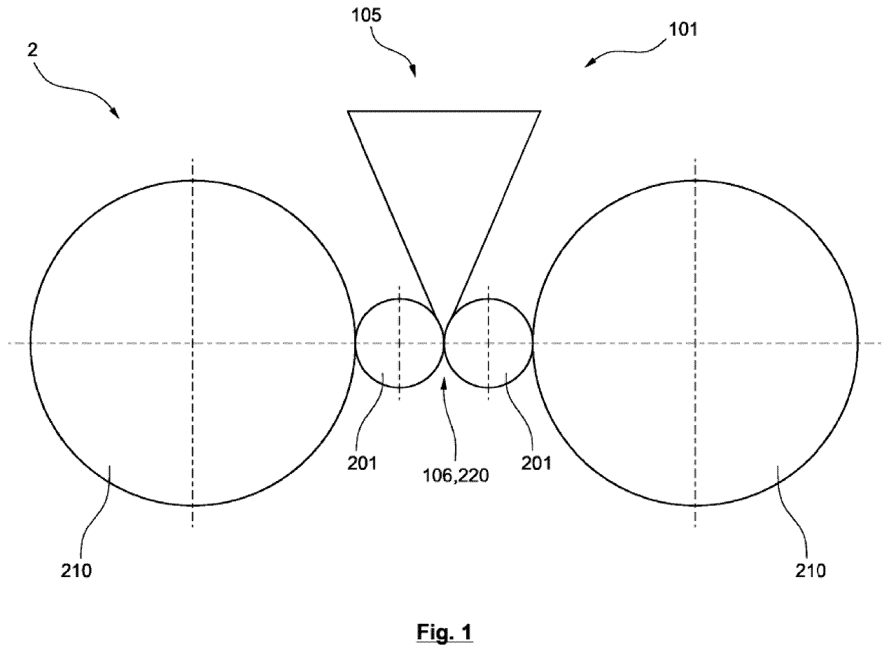

FIG. 1 shows a schematic side view of a powder hopper arranged above a nip of a dry electrode calender;

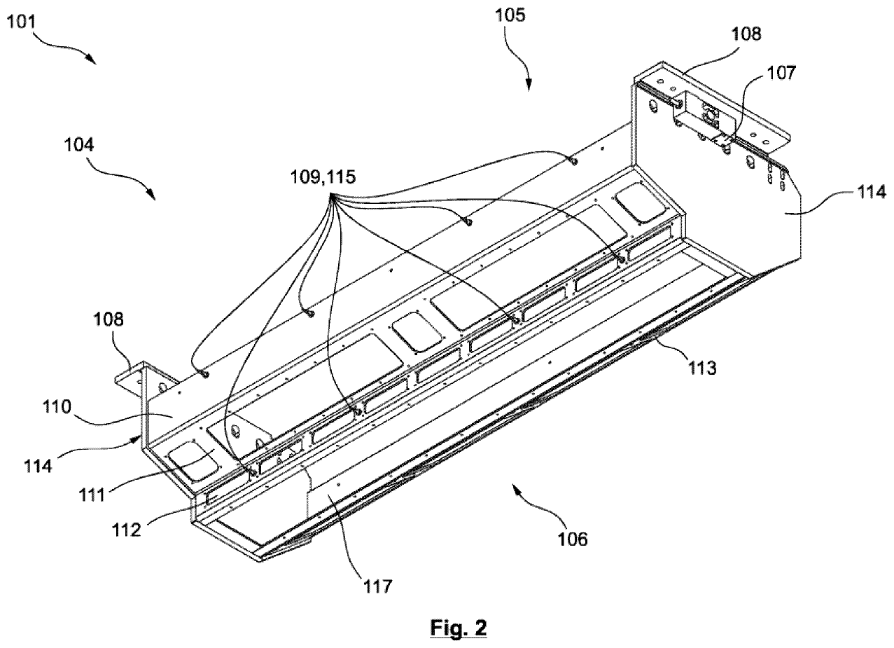

FIG. 2 shows a perspective view of an embodiment of a powder hopper having two capacitive fill level sensors and a weight detection device;

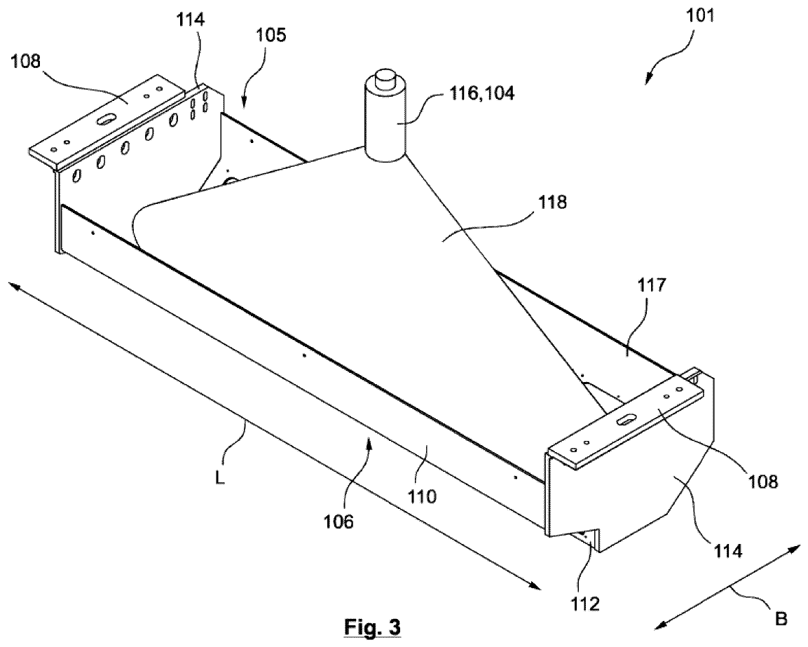

FIG. 3 shows a perspective view of an embodiment of a powder hopper having an optical fill level sensor;

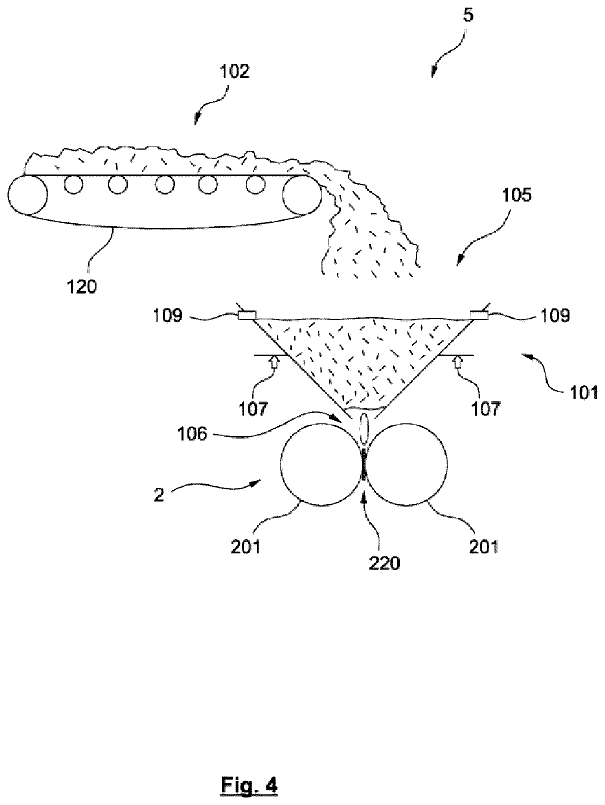

FIG. 4 shows a schematic representation of an embodiment of an assembly comprising a feed conveyor, a powder hopper, and a dry electrode calender;

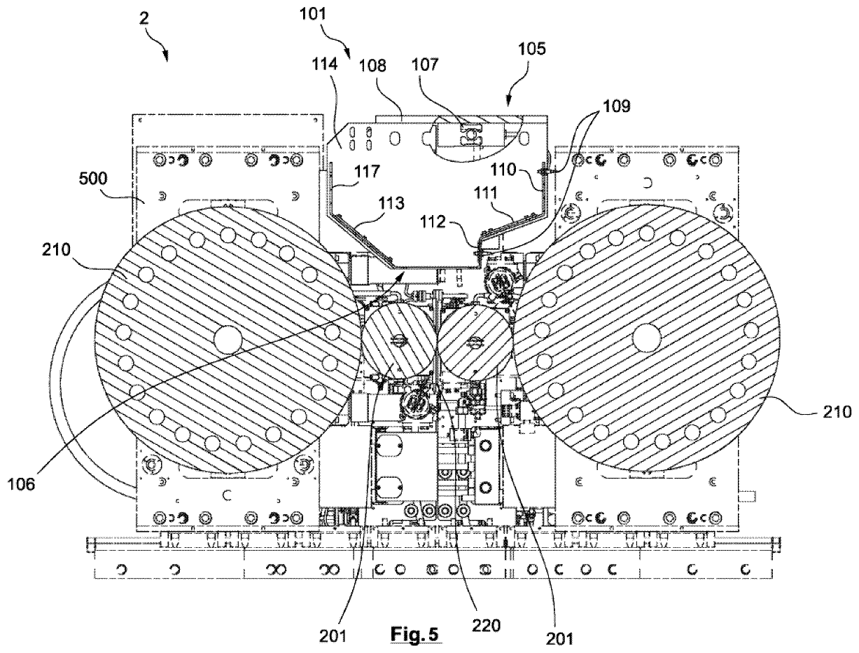

FIG. 5 shows a side view of an embodiment of a powder hopper mounted on a dry electrode calender;

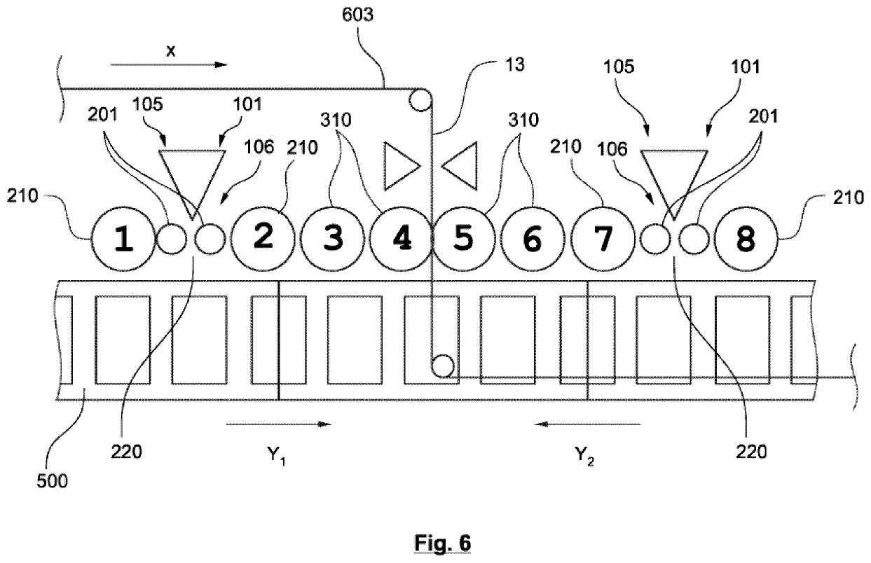

FIG. 6 shows a side view of an embodiment of a dry electrode calender for producing an electrode film from a powdered electrode precursor material; and

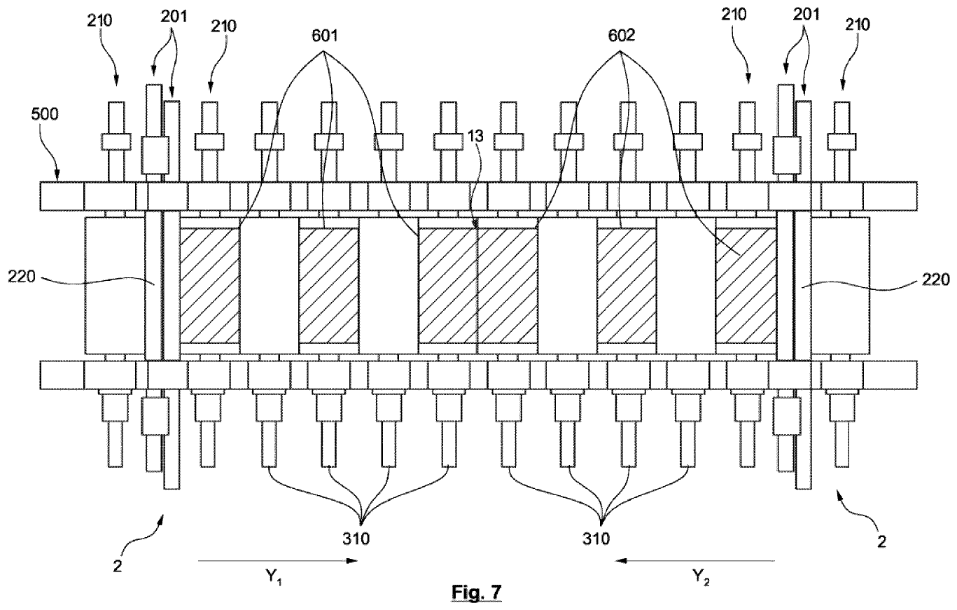

FIG. 7 shows a top view of an embodiment of a dry electrode calender for producing an electrode film from a powdered electrode precursor material.

The illustration shown in FIG. 1 shows an exemplary assembly of a powder hopper 101, which is arranged above a nip 220 of a dry electrode calender 2. The powder hopper 101 has a powder feed opening 105 on its upper side and a powder outlet opening 106 aligned with the nip 220 on its lower side. As a result, powdered electrode precursor material 102 fed into the powder feed opening 105 is fed via the powder outlet opening 106 into the nip 220 and rolled therein to form an electrode film 601 of defined width and thickness. The dry electrode calender 2 has two rolls 201 with a small diameter in the area of the powder feed, which exert a high surface pressure on the powder over the length of the nip 220. The rolls 201 are each supported laterally by adjacent support rolls 210, which prevent the rolls 201 from bending due to large forces acting in the nip, which occur in particular in the middle of the roll. The produced electrode film 601 is guided out of the nip 220 at the lower side thereof and around the right roll 201 and then conveyed through the nip between the right roll 201 and the right support roll 210 in order to homogenize the electrode film 601. Thus, a nip is also formed on these rolls, so that the support of the roll 201 is provided via the electrode film 601 guided through the nip. In contrast, no nip is formed between the left support roll 210 and the left roll 201. Therefore, these two rolls roll on each other, so that the roll 201 is directly supported by the support roll 210.

FIG. 2 shows a perspective view of the lower side of a powder hopper 101. This has a powder feed opening 105 on its upper side and a powder outlet opening 106 on its lower side, so that the powdered electrode precursor material 102 is conveyed by gravity from the powder feed opening 105 to the powder outlet opening 106. The width B of the powder hopper 101 tapers in the direction of the powder outlet opening 106. At each of its two longitudinal ends, the powder hopper has a vertical boundary wall 114, on the upper sides of each of which a support tab 108 is bent away from the powder feed opening 105. Load cells 107 are arranged below each of the support tabs 108, which measure the weight of the powder hopper 101 together with the powdered electrode precursor material 102 located therein, wherein the weight of the powder hopper 101 is subtracted in a higher-level control unit to determine the actual powder weight. In an upper region of the powder hopper 101, it has two opposite vertical wall sections 110, 117 in the longitudinal direction, which adjoin the powder feed opening 105. The rear wall section 117 shown in the illustration is adjoined in a lower region of the powder hopper 101 by an obliquely arranged wall 113, which directly adjoins the powder outlet opening 106 and tapers the width of the hopper 101 in the direction of the powder outlet opening 106. Opposite to the inclined wall 113, the powder hopper 101 has in the lower region, on the one hand, an inclined wall 111 and, on the other hand, a vertical wall 112 adjacent to the inclined wall 111, which in turn adjoins the powder outlet opening 106. The angle of inclination of the wall 111 is flatter than that of the opposite wall 113. The powder hopper 101 shown also has a fill level detection device 104, which comprises two fill level sensors 109. Of these, a first fill level sensor 109 is arranged on the vertical wall 112 bordering the powder outlet opening and a second fill level sensor 109 is arranged on the vertical wall 110 bordering the powder feed opening. Thus, by means of fill level sensors 109 at different levels of the hopper 101. it can be measured whether the powder fill level reaches the respective fill levels. Each of the fill level sensors 109 has four capacitive sensor units 115 arranged horizontally adjacent to one another, which are spaced apart from one another over the length L of the hopper 101. This means that uneven filling along the hopper 101 can also be detected if, for example, only one of the sensor units 115 detects the presence of powder, while the other three sensor units 115 located at the same height do not. This information can be evaluated by a higher-level control unit. Depending on the information received, the control unit can issue appropriate commands to the system. For example, an emergency stop of the system can be initiated if the fill level of the hopper 101 is too low, too high, or uneven in the longitudinal direction as described above. Furthermore, if the fill level is too low, a feed conveyor 120 connected upstream of the hopper 101 can be caused to increase the feed speed of powdered electrode precursor material 102 or, if the fill level is too high, it can be caused to reduce or stop the feed speed. The powder hopper 101 also has load cells 107, via which the hopper 101 is supported on the machine frame 500. This also provides the higher-level control unit with information about the development of the powder mass that is currently in the powder hopper 101. To ensure that a powder flow of constant density is fed to the nip 220, the control unit constantly determines the density of the powder in the hopper 101 from the information about the powder fill level and the information about the powder mass of the powder in the hopper 101. Accordingly, for example, the feed speed of the powder into the hopper 101 or even the speed of the rolls 201 can be adjusted.

FIG. 3 shows the powder hopper 101 of FIG. 2 having an alternative or additional optical fill level sensor 116 as the fill level detection device 104. This is arranged at a distance from the powder hopper 101 and is directed through the powder feed opening 105 onto the interior of the powder hopper 101. The detection range 118 of the optical fill level sensor 116 comprises the entire length L and the entire width B of the powder hopper 101. As a result, the powder volume in the powder hopper 101 and, in conjunction with the powder mass information, the powder density can be determined even more precisely.

As shown in FIG. 4, the powder hopper 101 is filled with as constant an amount of powdered electrode precursor material 102 as possible during operation. The powder hopper 101 can have one or more sensors, such as 103 and 104, configured to detect a characteristic of the powder 102 and/or the powder hopper 101. The weight detection device 103 is configured so that a weight of the powder 102 in the powder hopper 101 can be determined. The weight detection device 103 is configured such that it determines a total weight of the powder hopper 101 and determines the powder contained in the powder hopper 101 by subtracting the known hopper weight from the measured total weight. The weight detection of the powder hopper 101 can be carried out continuously, at periodic intervals, or at aperiodic intervals. A fill level detection device 104 is configured to determine a fill level of the powder 102 within the hopper 101. For example, the fill level detection device 104 can determine whether the powder 102 in the hopper 101 exceeds one or different height threshold values, wherein fill level detection sensors can be arranged on different hopper levels. Above the powder hopper 101, a feed conveyor 120 in the form of a belt conveyor is arranged, by means of which powdered electrode precursor material 102 is conveyed into the powder feed opening 105 of the hopper 101. Powder flows from the powder outlet opening 106 into the nip 220 arranged underneath, which is formed by the rolls 201. The density of the powder 102 in the hopper 101 is monitored via the load cells 107 and the fill level sensors 109, and if a density deviation from a target range is detected, the feed speed of the powder and/or the vertical distance of the feed conveyor from the powder hopper 101 is varied. For example, if the powder fill level is too low or the density is too low, the feed speed of the feed conveyor can be increased and/or its distance from the hopper 101 can be increased to produce higher powder compression. On the other hand, if the powder level is, for example, too high or the density is too high, the feed speed of the feed conveyor can be slowed down and/or its distance from the hopper 101 can be reduced in order to produce less powder compression.

FIG. 5 shows a powder mill of a dry electrode calender 2 in a side view. This has a calender frame 500, in which, on the one hand, the rolls 201 and the support rolls 210 that laterally support them are mounted and, on the other hand, a powder hopper 101 is mounted above the nip 202. The powder hopper 101 is arranged along the nip 220 and has a powder feed opening 105 directed upward and a powder outlet opening 106 directed towards the nip 220. The powder hopper 101 is supported on the calender frame 500 via load cells 107 via the support tabs 108 bent away from the upper edge of the side walls 114. The upper area and the lower area of the powder hopper 101 can be clearly seen, wherein the hopper has a constant width in the upper area with two opposite walls 110, 117, and a tapering width in the lower area with an inclined wall section 113 on the one hand and on the opposite side an inclined wall section 111 and an adjoining vertical wall section 112. It can also be seen that a capacitive fill level sensor 109 is arranged on each of the vertical walls 110 and 112 in the picture on the right at different hopper levels.

FIG. 6 shows a side view of a further embodiment of a multi-roll calender 3. This has two dry electrode calendars 2, which have opposite conveying directions Y1, Y2 of electrode films 601, 602. The roll assemblies mounted in a calender frame 500 each have a powder mill on the input side, which consists of two rolls 201 for squeezing the powdered electrode material 102 into electrode films 601, 602 as well as support rolls 210 supporting them adjacent to each other. As described above, the powder 102 is conveyed into the powder feed openings 105 of the powder hoppers 101 and conveyed into the nips 220 through the powder outlet openings 106, respectively. The electrode films 601, 602 then run in a serpentine pattern along their respective conveying directions Y1, Y2, first around the support roll 210 facing toward the end nip and then around the two conveyor rolls 310 arranged one behind the other up to the end nip 13, which is formed between the last rolls 310 at the ends of both dry electrode calendars 2. A separator film 603 is led from above through this gap 13 and is coated on both sides using the electrode films 601, 602. The separator film 603 is initially conveyed parallel to the direction Y1 along a direction X in the direction of the end nip 13.

FIG. 7 shows a top view of a further embodiment of a multi-roll calender 3, which shows the assembly of the rolls 201 in relation to the support rolls 210 in an integrated rolling system. As described above, the multi-roll calender 2 is used to produce a separator film 603 (not shown) coated on both sides using electrode films 601, 602. The assembly also has two calender assemblies 2 positioned frontally side by side, which have opposite main conveying directions Y1, Y2. The calender assemblies 2 each have eight rolls 201, 210, 310 mounted in a machine frame 500. On the input side, the assembly has two rolls 201 supported laterally by support rolls 210, which are used as a powder mill for producing the electrode films 601, 602 from a powdered electrode precursor material. The support rolls are followed by four conveyor rolls 310, which bring the electrode film to the desired width and thickness and homogenize it. The input-side end roll 301 is designed as a support roll 301 that rolls directly on the first roll 201. The output-side conveyor rolls 310 form a common end nip 13 in which the electrode films 601, 602 are applied to the separator film.

The features of the invention disclosed in the above description, in the figures and in the claims can be essential for the implementation of the invention both individually and in any combination.

### LIST OF REFERENCE NUMERALS

2 dry electrode calender
5 assembly
13 end nip
101 powder hopper
102 powdered electrode precursor material
103 weight detection device
104 fill level detection device
105 powder feed opening
106 powder outlet opening
107 load cell
108 support tab
109 fill level sensor
110 vertical side wall section bordering the powder feed opening
111 inclined side wall section
112 vertical side wall section bordering the powder outlet opening
113 inclined side wall section bordering the powder outlet opening
114 vertical side wall delimiting the length
115 sensor units
116 optical fill level sensor
117 vertical side wall section bordering the powder feed opening
118 detection zone
120 feed conveyor
201 roll
210 support roll
220 nip
310 conveyor rolls
500 calender frames
601 first electrode film
602 second electrode film
603 separator film
B width of powder hopper
L length of powder hopper
H height of powder hopper
X conveying direction of separator film
Y1 conveying direction of the first electrode film

Y2 conveying direction of the second electrode film

1. A powder hopper for gravity-driven feeding of powdered electrode precursor material into a nip of a dry electrode calender, having a powder feed opening for feeding powdered electrode precursor material into the powder hopper and a powder outlet opening for metering the powdered electrode precursor material from the powder hopper into a nip, wherein the cross section of the powder hopper tapers between the powder feed opening and the powder outlet opening, characterized in that the powder hopper has a level detection device for determining the powder level of the powder hopper.

2. The powder hopper according to claim 1, which furthermore has a weight detection device for determining the weight of powder in the powder hopper.

3. The powder hopper according to claim 2, wherein the weight detection device has at least one load cell on which the powder hopper is supported.

4. The powder hopper according to claim 3, wherein the powder hopper has at least one first and at least one second load cell and at least two support tabs which project laterally on opposite sides of the powder hopper, wherein the powder hopper is supported on the at least one first load cell via one of the support tabs and on the at least one second load cell via the other opposite support tab.

5. The powder hopper according to claim 1, wherein the powder hopper has a width (B) extending transversely to the nip and a length (L) extending along the nip, wherein the width (B) of the powder hopper decreases between the powder feed opening and the powder outlet opening and the length (L) of the powder hopper between the powder feed opening and the powder outlet opening is constant.

6. The powder hopper according to claim 1, wherein the fill level detection device has at least one first fill level sensor in the area above the powder outlet opening.

7. The powder hopper according to claim 1, wherein the fill level detection device has at least one second fill level sensor in the area below the powder feed opening.

8. The powder hopper according to claim 1, wherein the level detection device comprises at least one capacitive fill level sensor.

9. The powder hopper according to claim 6, wherein the fill level sensor has a plurality of sensor units distributed over the length of a side wall of the powder hopper and arranged at essentially the same height.

10. The powder hopper according to claim 9, wherein the side wall of the powder hopper having the plurality of sensor units is arranged substantially vertically.

11. The powder hopper according to claim 10, wherein the first fill level sensor has a first plurality of sensor units distributed over the length (L) of a first substantially vertical side wall of the powder hopper and arranged at substantially the same height, and wherein the second fill level sensor has a second plurality of sensor units distributed over the length (L) of a second substantially vertical side wall of the powder hopper and arranged at substantially the same height, wherein an inclined side wall connecting the first and the second side wall and tapering the width (B) of the powder hopper in the direction of the powder outlet opening is arranged between the first and the second side wall.

12. The powder hopper according to claim 1, wherein the level detection device comprises at least one optical fill level sensor.

13. The powder hopper according to claim 12, wherein the optical fill level sensor is directed at the interior of the powder hopper spaced apart from the powder hopper through the powder feed opening.

14. The powder hopper according to claim 12, wherein the detection range of the optical fill level sensor comprises at least the entire length (L) and the entire width (B) of the powder hopper.

15. The powder hopper according to claim 12, wherein the optical fill level sensor is configured to detect the filling volume of the powder hopper with powdered electrode precursor material.

16. The powder hopper according to claim 12, wherein the optical fill level sensor is furthermore configured to detect powder fill levels that are unevenly distributed over the length (L) of the powder hopper.

17. An assembly comprising a powder hopper according to claim 1 and a first and a second roll forming a nip, wherein the powder outlet opening of the powder hopper is arranged above and along the nip, so that the powdered electrode precursor material can be metered into the nip over this entire length of the powder outlet opening.

18. The assembly according to claim 17, wherein the assembly furthermore has a feed conveyor arranged above the powder hopper, by means of which powdered electrode precursor material can be conveyed into the nip.

19. The assembly according to claim 18, wherein the conveying speed of the feed conveyor is regulated depending on the powder density determined in the powder hopper, wherein the powder density is calculated on the basis of the powder filling height determined via the fill level detection device and the powder mass determined via the weight detection device.

20. The assembly according to claim 19, wherein the conveying speed is increased when the calculated powder density exceeds a first threshold value of a target range, and wherein the conveying speed is slowed down when the calculated powder density falls below a second threshold value of the target range.

21. The assembly according to claim 1, in which the powder hopper is conditioned on its inner sides, along which the powder is guided by gravity, to reduce friction with respect to the powder, preferably a coating or has an inlay having a low coefficient of friction in relation to the powder.

22. The assembly according to claim 1, in which the powder outlet opening has a gap aperture tapering in the direction of the nip and in the direction perpendicular to the axis of rotation of the rolls forming the nip, which is designed to meter the powder directly into the nip.

23. A method for operating a powder hopper, comprising the following steps:
Determining the fill level of the powder hopper with powdered electrode precursor material;
Determining the weight of the powdered electrode precursor material located in the powder hopper;
Calculating the density of the powdered electrode precursor material located in the powder hopper from the determined fill level and the determined weight;
Regulating a flow of powdered electrode material conveyed into the powder hopper.

24. The method according to claim 21, wherein regulating the flow of powdered electrode material fed into the powder hopper comprises regulating a conveying speed of a feed conveyor connected upstream of the powder hopper.

25. The method according to claim 21, wherein determining the fill level of the powder hopper comprises determining using a capacitive and/or optical sensor.

26. The method according to claim 21, wherein determining the fill level of the powder hopper can comprise determining the presence of powdered electrode precursor material on a first powder hopper level and determining the presence of powdered electrode precursor material on a second powder hopper level, wherein the height of the first powder hopper level can differ from the height of the second powder hopper level.

27. The method according to claim 21, wherein determining the weight of the powdered electrode precursor material located in the powder hopper comprises weighing the powder hopper minus the powder hopper weight.
